(19) United States
(12) Patent Application Publication
(10) Pub. No.: US 2026/0003229 A1
(43) Pub. Date: Jan. 1, 2026

(54) Directional Backlight Unit For Improved Artificial Reality Display

(71) Applicant: Meta Platforms Technologies, LLC, Menlo Park, CA (US)

(72) Inventors: Yun-Han Lee, Redmond, WA (US); Xiangtong Li, San Jose, CA (US); Yu-Jen Wang, San Jose, CA (US); Shenglin Ye, Santa Clara, CA (US); Xinyu Zhu, San Jose, CA (US)

(21) Appl. No.: 19/085,429

(22) Filed: Mar. 20, 2025

Related U.S. Application Data
(60) Provisional application No. 63/666,508, filed on Jul. 1, 2024.

(51) Int. Cl. G02F 1/1335; G02F 1/13357

(52) U.S. Cl. CPC G02F 1/133607; G02F 1/133526; G02F 1/133603

(57) ABSTRACT

Methods and systems for a liquid crystal display (LCD) device including a backlight with a plurality of light sources (e.g., light emitting diodes (LEDs)) are provided. The LCD device includes an LCD panel and a backlight for illuminating the LCD panel. The backlight includes a plurality of LEDs and a directional light guide plate. The directional light guide plate may be sectioned into quadrants. The plurality of light sources may be stacked and disposed behind the LCD panel positioned relative to directional light guide plate rotation. In an example, the LCD device may include a collimating layer and an extracting layer such that an extraction is variable.

### CROSS-REFERENCE TO RELATED APPLICATIONS

This application claims priority to U.S. Provisional Application No. 63/666,508, filed Jul. 1, 2024, entitled, “Directional Backlight Unit For Improved Artificial Reality Display,” the contents of which is incorporated by reference herein in its entirety.

### TECHNOLOGICAL FIELD

The present disclosure generally relates to systems or methods for augmented reality devices, and more specifically to backlights used in artificial reality devices.

### BACKGROUND

Artificial reality (AR) is a form of immersive reality that has been adjusted in some manner before presentation to a user, which may include, for example, a virtual reality, an augmented reality, a mixed reality, a hybrid reality, Metaverse reality or some combination or derivative thereof. In this regard, artificial reality devices often provide content through visual mechanisms, such as through a headset, e.g., glasses. Artificial reality content may include completely computer-generated content combined with captured (e.g., real-world) content. In some instances, artificial reality may be associated with applications, products, accessories, services, or some combination thereof, that may be used to, for example, create content in an artificial reality or are otherwise used in (e.g., to perform activities in) an artificial reality.

Many AR devices may include a backlight to provide illumination to pixels of liquid crystal displays (LCDs) to provide images associated with an AR device. Backlights may be used as an integral part of an optical system such that content may be displayed to a user.

### BRIEF SUMMARY

Various systems and methods are described for an enhanced liquid crystal display backlight system.

In an example, a liquid crystal display backlight system may include a liquid crystal display (LCD) panel and a backlight unit configured to illuminate the LCD panel. In some examples, the backlight unit may comprise a plurality of light emitting diodes (LEDs) and a directional light guide plate. The plurality of LEDs may be disposed behind the LCD panel and positioned at the corners of the LCD panel. The directional light guide plate may be disposed behind the LCD panel and adjacent to the plurality of LEDs. The directional light guide plate may be sectioned into four quadrants, wherein each quadrant may include two LEDs of the plurality of LEDs. One or more of the four quadrants are configured to create a different extraction angle associated with light from the plurality of LEDs. The directional light guide plate may be configured to direct light to the pixels of the LCD panel in a number of directions.

In an example, a liquid crystal display backlight system may include a liquid crystal display (LCD) panel and a backlight unit configured to illuminate the LCD panel. In some examples, the backlight unit may comprise a plurality of light emitting diodes (LEDs) and a directional light guide plate. The plurality of LEDs may be disposed behind the LCD panel and positioned at the along the edges of the LCD panel. The directional light guide plate may be disposed behind the LCD panel and adjacent to the plurality of LEDs. The directional light guide plate may be sectioned into four quadrants, wherein each quadrant may include two LEDs of the plurality of LEDs. Each of the LEDs associated with a quadrant may be positioned on different edges of the directional light guide plate. One or more of the four quadrants are configured to create a different extraction angle associated with light from the plurality of LEDs. The directional light guide plate may be configured to direct light to the pixels of the LCD panel in a number of directions.

In an example, a liquid crystal display backlight system may include a liquid crystal display (LCD) panel and a backlight unit configured to illuminate the LCD panel. In some examples, the backlight unit may comprise a plurality of light emitting diodes (LEDs) and a directional light guide plate. The plurality of LEDs may be disposed behind the LCD panel and positioned at the along the edges of the LCD panel, where four LEDs are positioned on opposite ends of the directional light guide plate. The directional light guide plate may be disposed behind the LCD panel and adjacent to the plurality of LEDs. The directional light guide plate comprises an extraction layer, wherein the extraction layer may comprise a pyramid shape along the surface. The backlight unit further may include a collimating layer configured to create an offset angle between an association between the extraction layer and the collimating layer. The directional light guide plate may be configured to direct light to the pixels of the LCD panel in a number of directions.

Additional advantages will be set forth in part in the description which follows or may be learned by practice. The advantages will be realized and attainted by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates a cross-sectional side view of a conventional LCD backlight system.

FIG. 2 illustrates a pancake lens associated with AR devices, in accordance with an example of the present disclosure.

FIG. 3A illustrates LCD backlight system in accordance with an example of the present disclosure.

FIG. 3B illustrates a directional light plate, in accordance with an example of the present disclosure.

FIG. 3C illustrates a surface associated with a directional light guide plate, in accordance with an example of the present disclosure.

FIG. 3D illustrates a surface associated with a directional light guide plate, in accordance with an example of the present disclosure.

FIG. 4A illustrates a directional light guide plate, in accordance with an example of the present disclosure.

FIG. 4B illustrates light emittance, in accordance with an example of the present disclosure.

FIG. 5 illustrates an example artificial reality device, in accordance with an exemplary embodiment.

FIG. 6 illustrates an example flowchart illustrating operations for an enhanced liquid crystal display backlight system in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the invention.

Many AR devices may include a LCD backlight system to provide illumination to pixels of liquid crystal displays (LCDs) to provide images associated with an AR device. Backlights may be used as an integral part of an optical system such that content may be displayed to a user. Although, backlights may be an integral part of optical systems the efficiency of LCD backlight systems may be problematic in some devices. Many conventional systems may reduce overall light throughput due to the user of multiple prism films and have low light recycling efficiency. Furthermore, due to the number of materials needed in conventional systems, many optical systems may be costly to make or manufacture. Not only are many conventional systems costly, but they may also lack the sufficient picture as the output light angle is normal to the LCD surface across the emission area. These problems may be exacerbated in AR devices, where picture quality may be affected as a user moves an eye, in such situations the light output angle normal to the LCD surface is insufficient in providing optimal viewing of AR content.

With the aforementioned context, the disclosed subject matter may include directional backlight unit capable of aiming light at different angles across display area to match pancake chief ray angle. In a first example, there may be a light guide plate (LGP) emission ray controlled by a sectionized prism-based directional LGP (DLGP) with a gradual change in prism angle to control the emission angle to match lens. In a second example, there may be an LGP emission ray controlled by a dual layer DLGP with one layer extracting light and the other bends light toward emission ray is bent in 1 dimension by tuning extraction prism angle, in which Fresnel film may be translational symmetric (Fresnel lenticular lens may bend ray outward in the 2nd dimension).

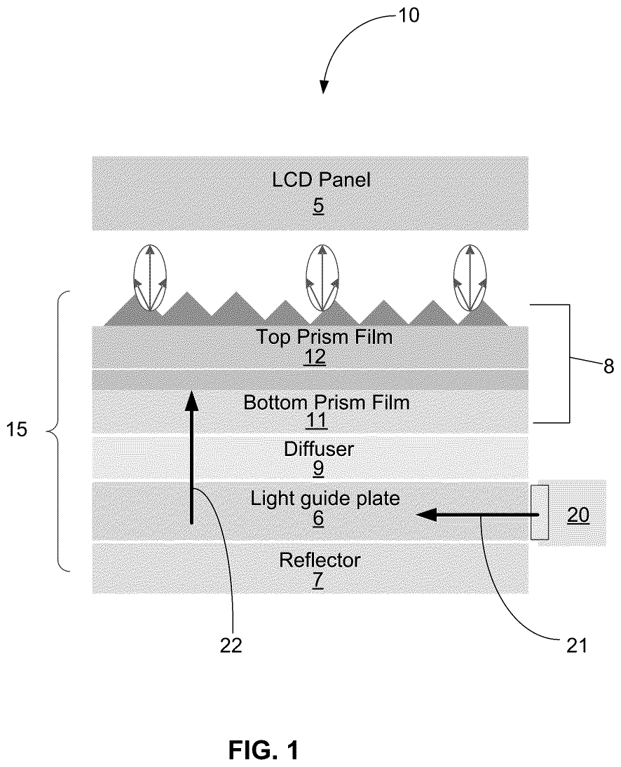

FIG. 1 illustrates an example cross-sectional side view of a conventional display system (discussed herein as an LCD backlight system 10). The LCD backlight system 10 may include an LCD panel 5, and a backlight unit 15. The backlight unit 15 may be disposed behind LCD panel 5. In some examples, backlight unit 15 may be disposed behind LCD panel 5 along a depth (“thickness”) of an electronic display, for example, in head-mounted displays (HMDs) associated with AR content. Backlight unit 15 may include a light source 20 (e.g., light-emitting diode (LED) light), a light guide plate 6, a reflector 7, and an optical film stack 8. In some examples the light guide 6 may be composed of glass material or a transparent plastic material, and refractive or reflective components for receiving light from the light source 20 in a first direction 21 and projecting light towards LCD panel 5 in a second direction 22. The first direction 21 may be parallel to the LCD panel 5 and the second direction 22 may be normal to the surface of reflector 7. In some examples, light guide plate 6 may comprise a series of unevenly spaced bumps that diffuse propagating light, wherein the density of the bumps may increase with distance to the light source 20. The light guide plate 6 may receive light from light source 20.

In some examples, the light propagated from light source 20 may comprise different colors or different wavelengths of light, where the light received by light guide plate 6 may direct the light in a direction toward the LCD panel 5, thus illuminating LCD panel 5. In some examples, light source 20 may comprise one or more LEDs disposed along one or more edges of LCD panel 5 to provide lighting to backlight unit 15. In some examples, the light source 20 may include vertically stacked LEDs. In some examples, light source 20 may comprise two or more vertically stacked LEDs. In some examples, an LED board may mechanically and electronically connect two or more vertically stacked LEDs. In some examples, the vertically stacked LEDs of light source 20 may be controlled separately. For example, light source 20 may include a first color LED and a second color LED emitting first light and second light at a first direction 21, respectively, at a first wavelength and a second wavelength, respectively. In some alternate examples, vertically stacked LEDs of light source 20 may be arranged along one or more edges of LCD panel 5, such as the left, right, top, and/or bottom edges.

The optical film stack 8 may include a diffuser 9 that facilitates the uniform distribution of light from the light guide plate 6 across the pixels of the LCD panel 5. The optical film stack 8 may additionally or alternatively include a number of prism films (e.g., bottom prism film 11 and top prism film 12) that reflects unpolarized light back toward the LCD panel 5, e.g., normal to the display surface.

Light guide plate 6 may direct light the top and bottom surfaces associated with the light guide plate 6, where the top surface may face the LCD panel 5 and the bottom surface may face the reflector 7. In some examples, reflector 7 may include an optical mirror that reflects light directed from the bottom surface of light guide plate 6 toward LCD panel 5. LCD panel 5 may include a plurality of liquid crystals. In some examples the orientation of the liquid crystals associated with LCD panel 5 may be changed according to a signal or potential difference across electrodes of an liquid crystal layer.

The orientation and setup of the conventional LCD backlight system 10 may reduce overall light throughput and reduce light recycling efficiency. Further the output light angle at LCD surface is normal, which may be insufficient in a number of devices. This may be the case due to the angle of the pupil of an eye as a user's eye may move. An output angle that is normal to the surface of the LCD surface would only provide an optimal output of AR content when a user is looking straight ahead or normal to the surface of the eyeball. Further, conventional LCD backlight system 10 may also require a number of materials, thus devices with LCDs may be costly.

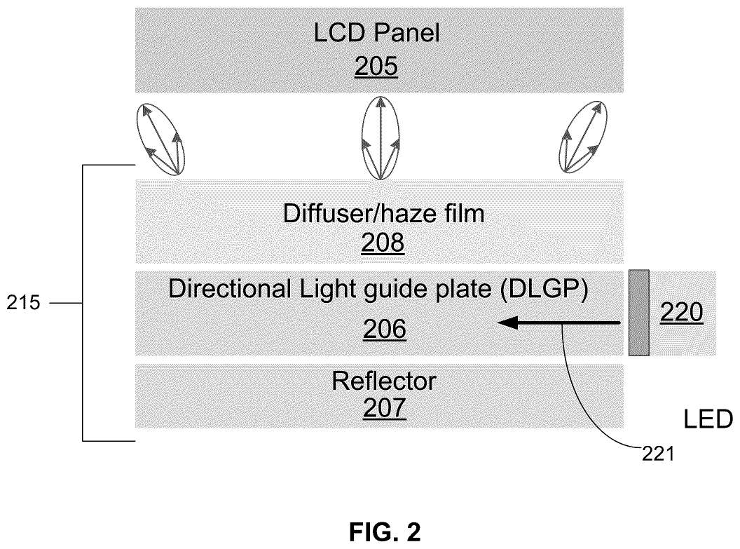

FIG. 2 illustrates LCD backlight system 200, in accordance with an example of the present disclosure. The LCD backlight system may include an LCD panel 205 and a backlight unit 215. The backlight unit 215 may be disposed behind LCD panel 205. In some examples, backlight unit 215 may be disposed behind LCD panel 205 along a depth (“thickness”) of an electronic display, for example, in head-mounted displays (HMDs) associated with AR content. Backlight unit 215 may include a light source 220 (e.g., light-emitting diode (LED) light), a directional light guide plate 206, a reflector 207, and an diffuser/haze film 208. In some examples the directional light guide plate 206 may be composed of glass material or a transparent plastic material, and refractive or reflective components for receiving light from the light source 220 in a first direction 221 and projecting light towards LCD panel 205 in a number of other directions. The first direction 221 may be parallel to the LCD panel 5 and the number of other directions may vary depending on the angle of incidence with directional light guide plate 206. In some examples, directional light guide plate 206 may comprise a series of unevenly spaced bumps that diffuse propagating light, wherein the density of the bumps may increase with distance to the light source 220. The directional light guide plate 206 may receive light from light source 220.

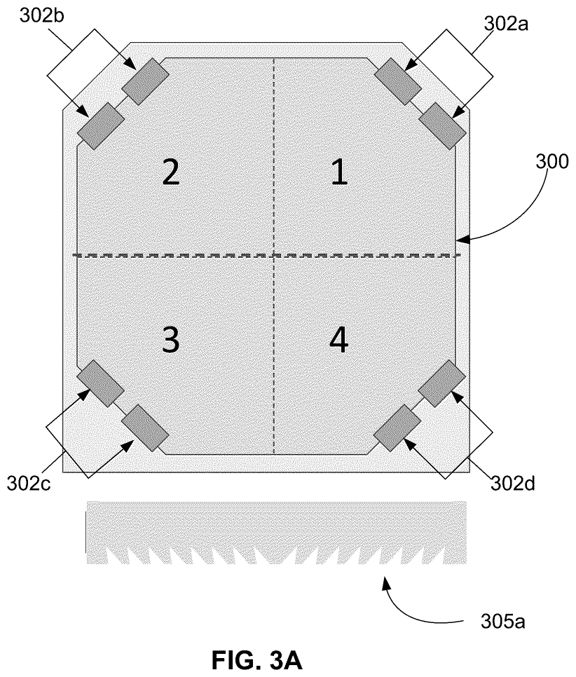

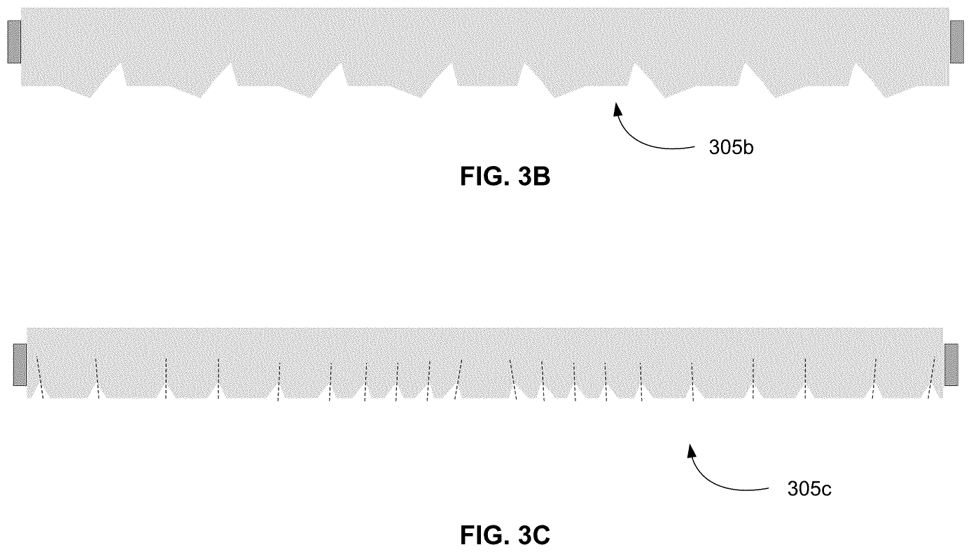

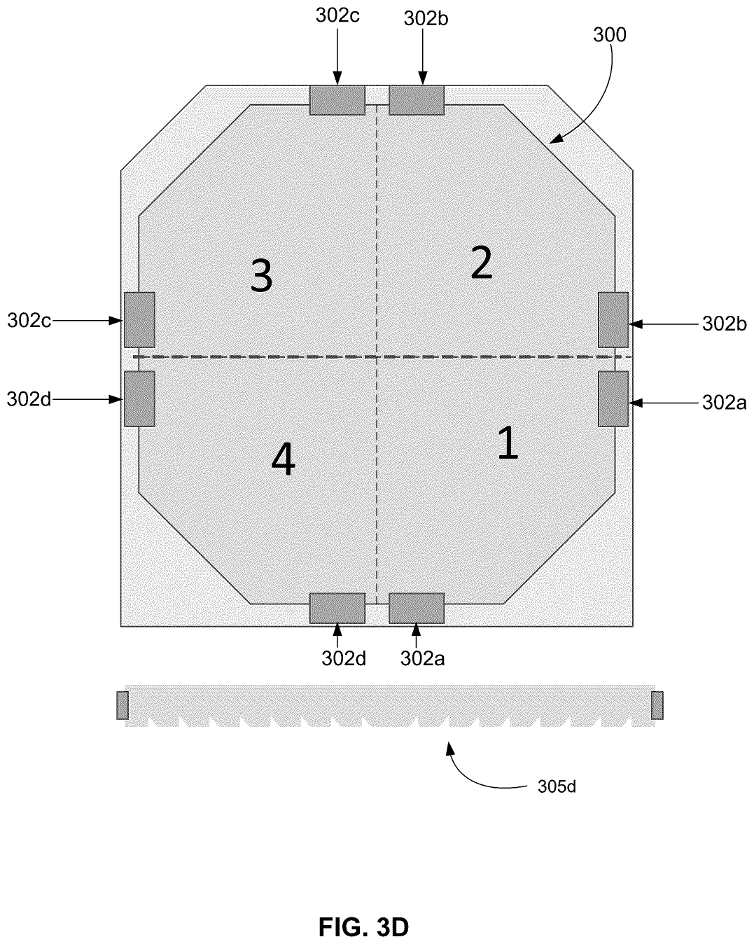

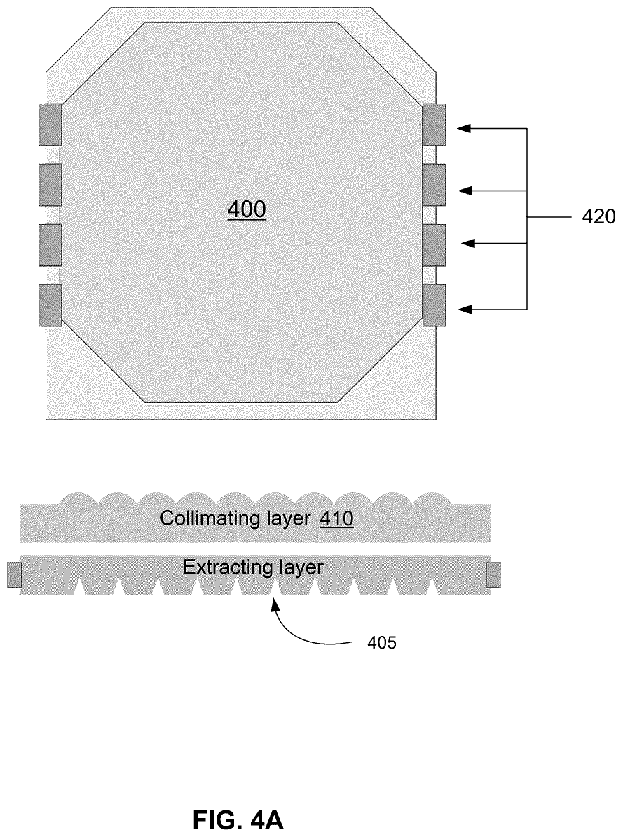

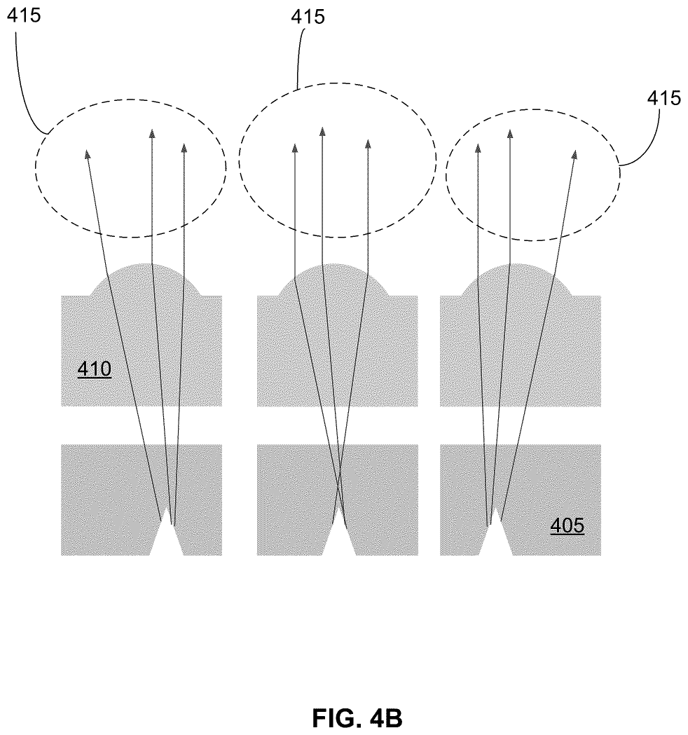

The light propagated from light source 220 may be similar to that of the light source 20 as described in FIG. 1. The diffuser/haze film 208 may be similar to that of the optical film stack 8 as described in FIG. 1. Light guide plate 206 may direct light the top and bottom surfaces associated with the light guide plate 206, where the top surface may face the LCD panel 205 and the bottom surface may face the reflector 207. In some examples, reflector 207 may include an optical mirror that reflects light directed from the bottom surface of light guide plate 206 toward LCD panel 205. LCD panel 205 may include a plurality of liquid crystals. In some examples the orientation of the liquid crystals associated with LCD panel 205 may be changed according to a signal or potential difference across electrodes of an liquid crystal layer. In the LCD backlight system 200, it is contemplated that the output angle of light may approach LCD panel 205 at different angles across the area of the display. This may be further described in the examples of FIG. 3A, 3B, 3C, 3D and FIG. 4A, 4B.

FIG. 3A illustrates a directional light guide plate 300, in accordance with an example of the present disclosure. The directional light guide plate 300 may be separated into 4 quadrants, where each quadrant may include two light sources 302 (e.g., LED lights), wherein each quadrant may have a different angle. For example, in quadrant one pattern may be created, in quadrant two another pattern may be created, in quadrant three another pattern may be created, and in quadrant four another pattern may be created, such that the pattern in each of the four quadrants may be different to capture LED light for each of the quadrants. The light source associated with quadrant one (e.g., 302a), the two LEDs may cause light output outside of quadrant one. Similarly, each quadrant (e.g., quadrant two, quadrant three, and quadrant four) may each include two LEDS (e.g., light source 302b, light source 302c, and light source 302d respectfully), wherein each output light towards an LCD panel (e.g., LCD panel 205) may be different in angle and each quadrant may have a different extraction. An example, surface 305a of FIG. 3A is a surface of directional light guide plate 300 depicted as a cross-sectional side view of directional light guide plate 300, where the surface 305a may comprise varying angles along the surface 305a of directional light guide 300. FIG. 3B and FIG. 3C, illustrate different possible extraction angles associated with the surface of directional light guide plate 300, wherein a quadrant as shown in FIG. 3A (e.g., quadrant one, quadrant two, quadrant three, or quadrant four, or any combination thereof) may have any of the extraction angles associated with the surface (e.g., bottom surface 305a, 305b, or 305c). Each surface (e.g., bottom surface 305a, 305b, 305c) may cause the light from light source(s) (e.g., light source 302a, light source 302b, light source 302c, and light source 302d) to be directed towards LCD panel (e.g., LCD panel 205) at a number of emission or extraction angles. It is contemplated that the surfaces (e.g., bottom surface 305a, 305b, 305c) may be in any manner of shape, bumps, or ridges, such that the emission angle towards LCD panel 205 may vary. Now in reference to FIG. 3D, the directional light guide plate 301 may be rotated 90° in contrast to directional light guide plate 300 of FIG. 3A, with a bottom surface 305d, thus illustrating another example of an emission angle associated with the directional light guide plate orientation.

FIG. 4A may illustrate a directional light guide plate 400, wherein the directional light guide plate 400 may be implemented in the LCD backlight system of FIG. 2. The bottom surface 405 may illustrate an extraction layer associated with a pyramid structure. The pyramid structure of the bottom surface 405 may be enable the extraction of light from the direction of the directional light guide plate 400. In FIG. 4 the LCD backlight system may further comprise a light source 420, wherein the light source 420 may comprise four or more LED lights positioned on opposite sides of a LCD backlight system (e.g., LCD backlight system 200). In FIG. 4 another layer may be added to the LCD backlight system of FIG. 2. The layer added may be a collimating layer 410, wherein the collimating layer 410 may comprise a microlens array that may allow the collimation of light coming from the extracting layer. In some alternative examples, light guide plate may further comprise a diffuser/haze film layer (e.g., diffuser/haze 208 film of FIG. 2), however, this diffuser/haze film layer may not be needed in the example of FIG. 4A. The configuration of the bottom surface 405 pyramid shape in conjunction with the collimating layer 410 may introduce or create an offset angle between the pyramid shape of bottom surface 405 and collimating layer 410. The offset angle may help aim the output light direction as illustrated in FIG. 4B, the offset angles 415 created by the relationship of bottom surface 405 and collimating layer 410. Although not illustrated in the FIG. 4B, it is to be appreciated that offset angles 415 depict emission of light towards a LCD panel (e.g., LCD panel 205). It is contemplated that the systems of FIG. 3A, 3B, 3C, 3D, and FIG. 4A, 4B may improve display brightness and reduce the cost of LCD backlight display systems. The cost may be reduced due to a reduced number of components necessary to achieve light emission to LCD panel 205.

It is contemplated that the angle of emission may also be altered in such LCD backlight systems (e.g., LCD backlight system 205) with the addition of one or more of a Fresnel lens or a flat lens, or a diffractive lens between the backlight unit 215 and the LCD panel 205. It is contemplated that herein the term LCD panel may be used interchangeably with the term display.

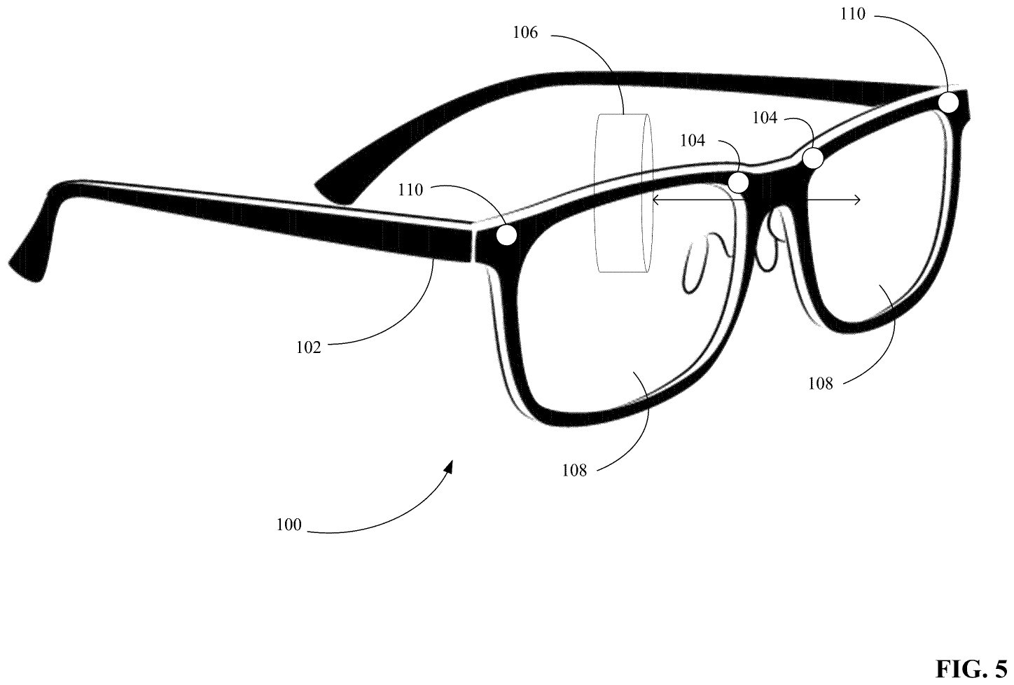

FIG. 5 illustrates an example head-mounted display 100 associated with artificial reality content, in accordance with an example of the present disclosure. HMD 100 may include enclosure 102 (e.g., an eyeglass frame), one or more cameras 104, a display(s) 108 (e.g., LCD display). The display(s) 108 may be configured to direct images to a surface 106 (e.g., a user's eye or another structure). In some examples, HMD 100 may be implemented in the form of augmented-reality glasses or virtual reality glasses. Accordingly, display(s) 108 may be at least partially transparent to visible light to allow the user to view a real-world environment through the display 108 (s).

Tracking of surface 106 may be beneficial for graphics rendering or user peripheral input. In many systems, HMD 100 design may include one or more cameras 104 (e.g., a front facing camera(s) away from a user or a rear facing camera(s) towards a user). Camera(s) 104 may track movement (e.g., gaze) of an eye(s) of the user or line of sight associated with the user. HMD 100 may include an eye tracking system to track the vergence movement of the user. Camera(s) 104 may capture images and/or videos of an area, or capture video and/or images associated with surface 106 (e.g., eyes of a user or other areas of the face of the user) depending on the directionality and view of camera(s) 104. In examples in which camera(s) 104 is rear facing towards a user, camera(s) 104 may capture images and/or videos associated with surface 106. In examples in which camera(s) 104 is front facing away from the user, camera(s) 104 may capture images and/or videos of an area. HMD 100 may be designed to have both front facing and rear facing cameras (e.g., camera(s) 104). There may be multiple cameras 104 that may be used to detect the reflection off of surface 106 and/or other movements (e.g., glint(s) or any other suitable characteristic(s)). Camera(s) 104 may be located on frame 102 in different positions. Camera(s) 104 may be located along a width of a section of frame 102. In some other examples, the camera(s) 104 may be arranged on one side of frame 102 (e.g., a side of frame 102 nearest to the eye). Alternatively, in some examples, the camera(s) 104 may be located on display(s) 108. In some examples, camera(s) 104 may be a sensor(s) or a combination of cameras and sensors to track one or more eyes (e.g., surface 106) of a user.

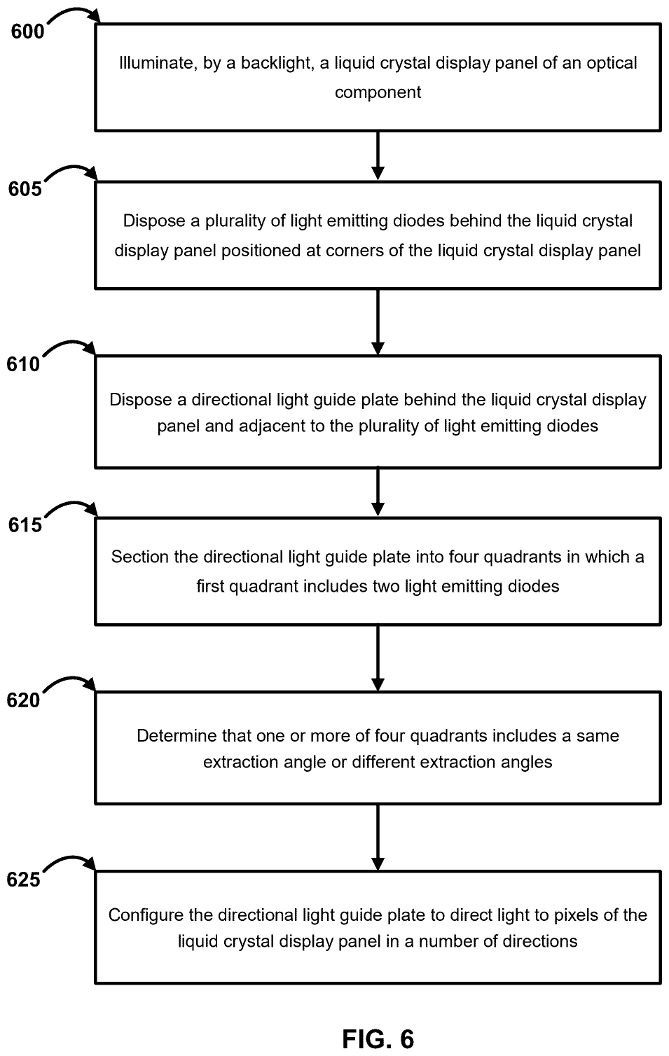

FIG. 6 illustrates an example flowchart illustrating operations for an enhanced liquid crystal display backlight system according to an example of the present disclosure. At operation 600, the method may include illuminating, by a backlight, a liquid crystal display panel of an optical component. At operation 605, the method may include disposing a plurality of light emitting diodes behind the liquid crystal display panel positioned at corners of the liquid crystal display panel. At operation 610, the method may include disposing a directional light guide plate behind the liquid crystal display panel and adjacent to the plurality of light emitting diodes.

At operation 615, the method may include sectioning the directional light guide plate into four quadrants in which a first quadrant includes two light emitting diodes. At operation 620, the method may include determining that one or more of four quadrants includes a same extraction angle or different extraction angles. At operation 625, the method may include configuring the directional light guide plate to direct light to pixels of the liquid crystal display panel in a number of directions.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. An optical component comprising:
a liquid crystal display panel; and
a backlight configured to illuminate the liquid crystal display panel, the backlight comprising;
a plurality of light emitting diodes disposed behind the liquid crystal display panel positioned at corners of the liquid crystal display panel; and
a directional light guide plate disposed behind the liquid crystal display panel and adjacent to the plurality of light emitting diodes, wherein:
the directional light guide plate is sectioned into four quadrants, wherein a first quadrant comprises two light emitting diodes;
one or more of four quadrants comprises a same extraction angle or different extraction angles; and
the directional light guide plate is configured to direct light to pixels of the liquid crystal display panel in a number of directions.

2. An optical component comprising:
a liquid crystal display panel; and
a backlight configured to illuminate the liquid crystal display panel, the backlight comprising;
a plurality of light emitting diodes disposed behind the liquid crystal display panel positioned along edges of the liquid crystal display panel; and
a directional light guide plate disposed behind the liquid crystal display panel and adjacent to the plurality of light emitting diodes, wherein:
the directional light guide plate is sectioned into four quadrants, wherein a first quadrant comprises two light emitting diodes, wherein a light emitting diode of the first quadrant is positioned on different edges of the directional light guide plate;
one or more of four quadrants produce different extraction angles; and
the directional light guide plate is configured to direct light to pixels of the liquid crystal display panel in a number of directions.

3. An optical component comprising:
a liquid crystal display panel; and
a backlight configured to illuminate the liquid crystal display panel, the backlight comprising:
a plurality of light emitting diodes disposed behind the liquid crystal display panel positioned along edges of the liquid crystal display panel; and
a directional light guide plate disposed behind the liquid crystal display panel and adjacent to the plurality of light emitting diodes, wherein:
opposite sides of the directional light guide plate have four light emitting diodes;
an extraction layer of the directional light comprises a pyramid shape;
the directional light guide plate is configured to direct light to pixels of the liquid crystal display panel in a number of directions; and
a collimating layer configured to create an offset angle between an association with the collimating layer and the extraction layer.

4. The optical component of claim 3, wherein the collimating layer comprises a microlens pattern.
